(19) United States
(12) Patent Application Publication
(10) Pub. No.: US 2004/0051381 A1
(43) Pub. Date: Mar. 18, 2004

(54) Pneumatic arrangement comprising a plurality of servicing modules for the preparation of compressed air

(75) Inventors: Jens Garner, Stuttgart (DE); Gunter Gebauer, Esslingen (DE); Klaus Keinrad, Kongen (DE)

Correspondence Address: Charles R. Hoffmann, HOFFMANN & BARON, LLP., 6900 Jericho Turnpike, Syosset, NY, 11791, US

(73) Assignee: Festo AG & Co.

(21) Appl. No.: 10/643,232

(22) Filed: Aug. 18, 2003

(30) Foreign Application Priority Data
Sep. 17, 2002 (DE) 102 42 969.3

(51) Int. Cl. H02J 1/00

(52) U.S. Cl. 307/11

(57) ABSTRACT

A pneumatic arrangement comprising a plurality of servicing modules for the preparation of compressed air which are arranged on a common bus system adjacent to each other. Furthermore a control module for the implementation of control or/or monitoring functions and/or communication functions is connected with the bus system for the servicing modules. In addition a valve arrangement is connected with the common bus system, the control module also being adapted for the performance of control or/or monitoring functions for the valves of the valve arrangement, the valve arrangement constituting a subassembly with the servicing modules. As a result only one single control module is required for the servicing modules and the valve arrangement, there being a compact subassembly without unsupported connecting lines.

### BACKGROUND OF THE INVENTION

The invention relates to a pneumatic arrangement comprising a plurality of servicing modules for the preparation of compressed air, which are arranged on a common bus system, and a control module connected with the bus system for the performance of control and/or monitoring functions and/or communication functions for the servicing modules.

### THE PRIOR ART

Such an arrangement for the preparation of compressed air is for instance disclosed in the European patent publication 0 909 898 A1. For every pneumatic system such a compressed air preparation arrangement is required in order to set the pressure and the oil content and to filter the compressed air arriving from the compressed air source. Practically actuators such as power cylinders, grippers, drives and servo devices, require valves in operation for the control of the supply and discharge of compressed air or vacuum. Such valves are collected together in conventional manner as valve arrangements, each of such valve arrangement comprising several valves being provided with an electronic control means, which for its part is connected by way of a field bus line with a central control unit. Taking this prior art as a starting point one aim of the present invention is to create more economic pneumatic arrangements with a reduction in the number of control devices or, respectively, control modules.

### SHORT SUMMARY OF THE INVENTION

In order to achieve these and/or other objects appearing from the present specification, claims and drawings, in the present invention a valve arrangement is also connected with such common bus system, the control module being also designed for the implementation of control and/or monitoring functions for the valves of the valve arrangement and together with the) servicing modules the valve arrangement constitutes a subassembly.

It is then an advantage that only one single control module is necessary for compressed air preparation and valve control, this resulting in a compact subassembly without free unsupported connecting lines. In this case full adaptability is still maintained, since any further possible servicing modules or valves desired can be connected with the common bus system, such modules or valves respectively as a whole constituting the compact subassembly.

The further features recited in the dependent claims herein relate to further advantageous developments and improvements in the pneumatic arrangement defined in claim 1.

The valves and the servicing modules are preferably arranged on a common bus system in a juxtaposed manner and so constitute the subassembly. This arrangement facilitates the mounting of additional valves or the removal of valves and servicing modules present.

Furthermore a particularly high degree of variability is achieved by designing the bus system as a bus conductor bar, which preferably comprises individual bar elements able to be plugged together, the modules and the valve arrangement being able to be lined up on this bus conductor bar. Even in the case of a change in the geometrical sequence of the modules and the valve arrangement or in the case of a further expansion thereof by adding further modules it is possible for the bus conductor to be adapted by simple repluggng without any danger of misconnecting anything. It is more particularly in the case of individual bar elements able to be plugged together that a simple adaptation in length is possible to suit the module and valve arrangements. The bus conductor bar may even be responsible for the mechanical connection of the modules or at least contribute to such mechanical connection.

The control module may be integrated in one of the servicing modules or may be arranged as a separate module on the bus system or on the valve arrangement. It is preferably arranged between the valve arrangement and the servicing modules.

For the pneumatic connection between the servicing modules and the valve arrangement a pneumatic adapter module is preferably located between same on the bus system. Same may also serve for electrical adaptation, if necessary.

It is an advantage for the control module to possess a field bus interface for an external bus system so that the control module may be connected with a external central control unit. This external central control unit can influence or modify functions of the control module or furthermore directly access the servicing module or, respectively, the valve arrangement. On the other hand it is possible for the control module to have its own intelligence so that during normal operation a connection with the central control unit is unnecessary.

In order to modify settings in situ a display and/or operating unit is preferably integrated in the control module or connected as a separate unit with the control module, more particularly by way of ethernet or functionally connected with it in a wireless manner.

The servicing modules and/or the valves of the valve arrangement are at least in part provided with sensors and/or diagnostic means and more especially with pressure sensors, whose signals are able to be transmitted by way of the bus system to the control module. This on the one hand permits monitoring by the control module and on the other hand parameter-dependent control and setting of the servicing modules and of the valve arrangement using the control module.

The control module may also preferably provided with a monitoring and/or diagnostic means for the valve arrangement and the servicing modules so that improper function or other faults may be immediately detected. By way of the field bus interface diagnostic access is also possible by the external central control unit.

Further advantageous developments and convenient forms of the invention will be understood from the following detailed descriptive disclosure of one embodiment thereof in conjunction with the accompanying drawings.

### LIST OF THE SEVERAL VIEWS OF THE FIGURES

FIG. 1 is a perspective view of a subassembly, comprising servicing modules and a valve arrangement, as one embodiment of the invention.

FIG. 2 shows the same arrangement from above.

### DETAILED ACCOUNT OF WORKING EMBODIMENT OF THE INVENTION

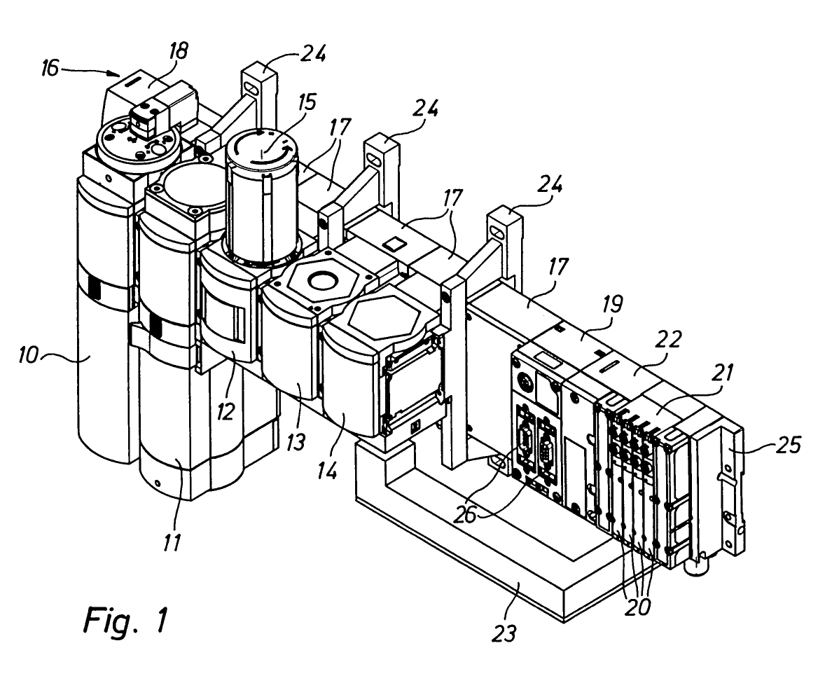

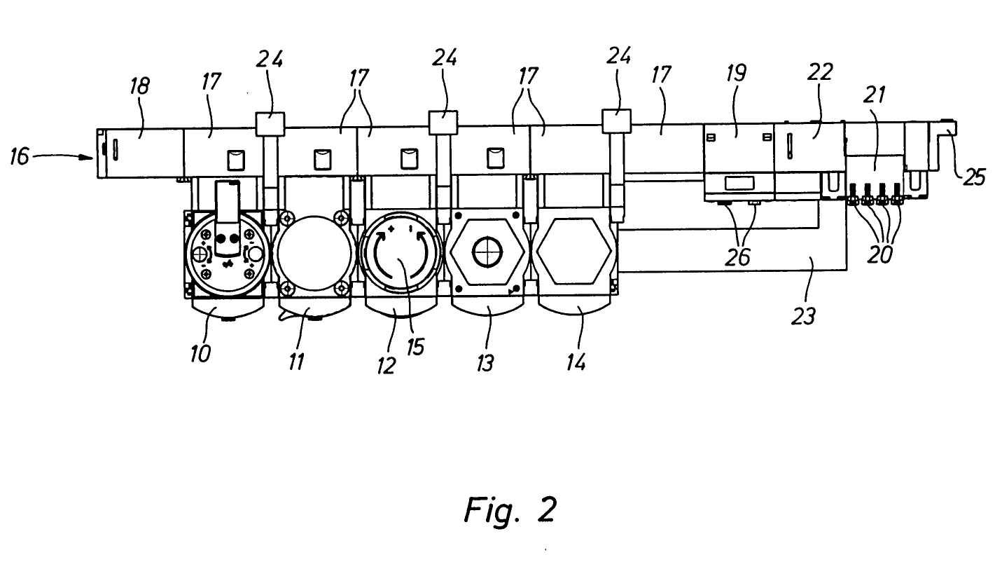

In the case of the working example represented in FIGS. 1 and 2 five servicing modules are connected together in sequence for the preparation of compressed air. It is a question in this case of a valve module 10 on the left, a filter module 11, a pressure regulating valve 12, a distributing module 13 and an adapter module 14 on the right. The switching valve module 10 possesses a switching valve (not illustrated in detail) in order to shut off or permit the passage of compressed air supplied at the inlet from a source of compressed air, as for example a compressor, in a manner which is not illustrated in detail. The filter module 11 for example comprises a fine filter in order to filter the compressed air. The pressure regulating 12 sets the desired pressure, which is to be predetermined, using a rotary means 15. The distributing module 13 serves for pressure distribution to the pneumatic lines, which are to be connected, and for passing on the pressure to the adapter module 14 which is juxtaposed.

The five modules 10 through 14 may also be connected in a different sequence, it being possible for other modules with suitable functions to be attached, such as a softstart module for control and pressure build up, an oiler module for metering the added oil or a rate of flow measuring module for the measurement of the rate of air flow. It is also possible for example to provide for a plurality of module functions in a single module, as for example a combined pressure regulator and filter module.

The modules 10 through 14 are plugged to a bus system 16 or secured in some other manner, such bus system being in the form of a bus conductor bar consisting of bar elements 17 able to be plugged together. In the bus conductor bar of the bus system 16 in addition to the actual bus conductors power supply conductors are also accommodated. In its region facing the bus system 16 each of the modules 10 through 14 comprises a bus participant station for communication with the bus system. This is described in the initially mentioned prior art in more detail.

At one end the bus conductor bar of bus system 16 is provided with a terminating element 18 and at the opposite end an electronic control module 19 is connected. In turn a valve arrangement 21 constituting of individual valves 20 is placed following the control module 19, it being connected by way of a connecting module 22. By way of the latter the bus system and also the compressed air is connected with and, respectively, supplied to the valve arrangement 21. a pressure conductor element 23 serves to connect the adapter module 14 with the connecting module 22. The connecting module 22 may comprise one or more bus participant stations for the valves 20 of the valve arrangement 21 or each valve 20 may possess its own bus participant station.

As a modification of the illustrated arrangement the control module 19 and the valve arrangement 21 may also be connected with the modules 10 through 14 at the extended bus conductor bar of the bus system 16.

For the attachment of the entire arrangement holders 24, connected with the modules 10 through 14 and also a terminal holder 25 on the valve arrangement 21 are employed.

The control module 19 serves for the control and/or monitoring in the modules 10 through 14 and of the valve 20 of the valve arrangement 21. For monitoring the modules 10 through 14 and, respectively, the valves 20 are provided with sensors such as pressure sensors, temperature sensor or the like, which pass on their signals by way of bus system 16 to the control module 19. For this purpose the control module 19 may contain a diagnostic program. The control module 19 may however also assume control and setting functions for the modules 10 through 14 and the valves 20. For this purpose a controller is comprised in the module 19 for control functions, setting functions, monitoring functions and/or diagnostic functions.

The control module 19 furthermore possesses a field bus interface, by way of which communication with an external control computer is end. For this purpose use is made of connection devices 26. Monitoring and diagnostics may in principle also take place by way of the field bus, modification of the program of the control module 19 also being possible. Moreover the direct implementation of control functions, monitoring functions, setting functions and diagnostic functions may take place using the external computer. As required the controller of the control module 19 comprises its own intelligence for the performance of such functions. In the simplest case the control module 19 is also designed in the form of a field bus interface for the transmission of signals between the participants and the external computer.

As a modification of the illustrated working embodiment the functions of the control module 19, as for instance the field bus interface function, may also be integrated in one of the modules 10 through 14 or in the connection module 22.

For direct programming and for the implementation of settings in situ the control module 19 may be provided with a display and/or operating unit, which may be in the form of an integrated display and/or operating unit or as a separate display and/or operating unit. In the case of a separate display and/or operating unit same may be connected by way of a connection plug device with the control module 19 if required.

In a manner which is not illustrated further electronic components, as for instance digital and analog input/output modules, programmable logic controllers modules and the like may be connected to the bus conductor bar of the bus system 16 with an elongation using additional bar elements 17. Furthermore other pneumatic components such as pneumatic actuators, may be added to the unit.

The valves 20 may be switching and/or proportional valves, safety valves or vacuum components, as for example vacuum switching valves.

The individual modules and more especially the control module, may be so programmed that the system configures itself automatically on the addition or removal of modules. This means that each module added identifies itself automatically.

The control module 19, the separate display and/or operating unit—if present—or any other components of the pneumatic arrangement may be provided with a optical and/or acoustic alarm means in order to indicate diagnostic messages, more especially fault and the transgression of limiting value optically and/or acoustically.

Dependent on the design of the bus conductor bar and, respectively, of the bar elements 17 it is possible in individual cases to also provide a direct connection of lines between the modules or, respectively, valves or an interruption of the power supply lines in order to have separate supply of power. The provision of separate supplies of power permits the formation of independent power zones or, respectively, voltage zones, as for example for actuators.

1. A pneumatic arrangement comprising a plurality of servicing modules for the preparation of compressed air, which are arranged on a common bus system, and a control module connected with the bus system for the performance of control and/or monitoring functions and/or communication functions for the servicing modules, wherein a valve arrangement is also connected with such common bus system, the control module being also designed for the implementation of control and/or monitoring functions for the valves of the valve arrangement together with the servicing modules and the valve arrangement constitutes a subassembly.

2. The pneumatic arrangement as set forth in claim 1, wherein the valves and the servicing modules are arranged in a row on the common bus system.

3. The pneumatic arrangement as set forth in claim 1, wherein the bus system is designed in the form of a bus conductor bar, which preferably comprises individual bar elements able to be plugged or attached together, the modules and the valve arrangement being able to be arranged in a row with the bus conductor bar.

4. The pneumatic arrangement as set forth in claim 1, wherein the control module is integrated in one of the servicing modules or is arranged as a separate module on the bus system or on the valve arrangement.

5. The pneumatic arrangement as set forth in claim 4, wherein the control module is arranged between the valve arrangement and the servicing modules.

6. The pneumatic arrangement as set forth in claim 1, wherein an electrical and/or pneumatic adapter module is arranged between the valve arrangement and the servicing modules on the bus system.

7. The pneumatic arrangement as set forth in claim 1, wherein the control module possesses a field bus interface for an external bus system.

8. The pneumatic arrangement as set forth in claim 1, wherein the display and/or operating unit is integrated in the control module or as a separate component is connected or adapted to be connected with the control module, more especially by way of ethernet or in a wireless manner is functionally connected with the control module.

9. The pneumatic arrangement as set forth in claim 1, wherein the servicing modules and/or valves of the valve arrangement are at least partly provided with sensors and/or specific diagnostic means, more particularly with pressure sensors, whose output signals are able to be transmitted by way of the bus system to the control module.

10. The pneumatic arrangement as set forth in claim 9, wherein the control module is provided with a monitoring and/or diagnostic means for the valve arrangement and the servicing modules, such means being more especially adapted to be effective for more than one system.

11. The pneumatic arrangement as set forth in claim 1, comprising optical and/or acoustic message alarm indicating means, such means serving more especially for diagnostic messages.
